(19) United States
(12) Patent Application Publication
(10) Pub. No.: US 2019/0142152 A1
(43) Pub. Date: May 16, 2019

(54) A CLEANING ASSEMBLY

(71) Applicant: Ignatius Richard Stanley BLAKEWAY, Brisbane (AU)

(72) Inventor: Ignatius Richard Stanley BLAKEWAY, Brisbane (AU)

(21) Appl. No.: 16/091,512

(22) PCT Filed: Mar. 31, 2017
(86) PCT No.: PCT/AU2017/050280

§ 371 Date: Oct. 4, 2018

(30) Foreign Application Priority Data
Apr. 4, 2016 (AU) 2016901239
Feb. 9, 2017 (AU) 2017900401

(51) Int. Cl. A46B 11/06; B05B 15/65; B05B 1/16

(52) U.S. Cl. CPC A46B 11/06; B05B 1/1654; B05B 15/65

(57) ABSTRACT

A cleaning assembly for attachment to a spray nozzle head including a head member having a head portion with an aperture, and a cleaning skirt extending from the head portion when in use, and a spray nozzle head collar attachable to the spray nozzle head and positionable at least partially within or outside of the aperture to allow discharge of liquid from the spray nozzle head through the aperture.

This application claims the benefit of Australian Patent Application No. 2016901239, filed Apr. 4, 2016, and Australian Patent Application No. 2017900401 filed Feb. 9, 2017 which are hereby incorporated by reference in their entirety.

### FIELD OF INVENTION

The present invention relates to a cleaning assembly for attachment to a spray nozzle head. The present invention has particular but not exclusive application for attachment to a spray nozzle head having a selector ring. The patent specification describes this use but it is by way of example only and the invention is not limited to this use.

### BACKGROUND OF THE INVENTION

Brushes attached to hoses are used to clean cars and boats. There have been a variety of brush-hose products that have been developed and marketed.

However, a person needs to scrub the car or boat to dislodge the dirt and grime. The water trickles out of the brush hose end and has no direct action on the dirt and grime. Water from the hose keeps the bristles of the brush hose end wet. It is the bristles of the brush portion that removes the dirt and grime through the scrubbing action by the user. Consequently, the amount of dirt and grime removed from the car or boat depends on the amount of scrubbing.

### OBJECT OF THE INVENTION

It is an object of the present invention to overcome or at least alleviate one or more of the above problems by providing an improved cleaning assembly and/or provide the consumer with a useful or commercial choice.

### SUMMARY OF THE INVENTION

In one aspect, the present invention broadly resides in a cleaning assembly for a hose, the assembly including

a head member having an aperture; and

a connector for connecting the hose to the aperture, wherein the connector has sloping sides so that the hose forms a friction fit with the connector.

In another aspect, the present invention broadly resides in a cleaning assembly for use with a hose attachment, the cleaning assembly including

a head member having an aperture; and

a connector for connecting the hose attachment to the aperture, the connector having at least one tapered or convergent portion to allow the hose attachment to be inserted at least partially therein and form a friction fit with the connector.

Preferably the hose attachment is a spray nozzle head. In one embodiment, the hose attachment is a water wand with a circular shaped spray nozzle head.

Preferably the connector is a hollow, frustoconically shaped body with tapered, convergent or sloping internal sides, converging toward the brush head when in use. Preferably the connector enables the head member to be fitted to spray nozzle heads of different sizes. The connector may be referred to as a spray nozzle head collar. In one embodiment, the cleaning assembly includes a plurality of spray nozzle head collars of different sizes to enable the head member to be fitted to spray nozzle heads of different sizes.

Preferably the connector has one or more lips. More preferably the connector has a lip. Preferably the lip assists to prevent unintended withdrawal of the spray nozzle head from the spray nozzle head collar.

In one embodiment, the cleaning assembly may include one or more shims. Preferably the one or more shims are locatable between the connector and the hose attachment to form the friction fit between the hose attachment and the connector. Preferably each of the one or more shims has one or more lips. More preferably each of the one or more shims has a lip. In one embodiment, the cleaning assembly has a shim made of rubber or neoprene. Preferably the shim has a first lip to engage with a first side of the connector and a second lip to engage with a second side of the connector. Alternatively, the shim may have a rebate portion which engages on a first end with a first side of the connector and at a second end with a second side of the connector. Preferably the shim is tapered to accept different sized hose attachments.

Preferably the connector is locatable at least partially within the aperture. Preferably the aperture has a tapered, convergent or sloping wall. Preferably when the connector is located at least partially within the aperture, the connector forms a friction fit with the wall of the aperture. Preferably the connector has a tapered, convergent or sloping external portion or surface. Preferably the tapered, convergent or sloping external portion or surface corresponds to the tapered, convergent or sloping wall of the aperture.

The connector may include more than one portion or part. The connector may be provided in the form of an elbow with a convergent portion for attachment of the hose attachment and a second or further portion mounted to or for mounting to the head member.

Preferably the aperture is located off-centre relative to the head portion. Preferably the aperture is located off-centre so that a nozzle of the spray nozzle head is positioned substantially in the centre of the head portion to evenly distribute water relative to the head portion.

Preferably a cleaning skirt extends from the head portion in use. The cleaning skirt is preferably integrally formed with or attachable to the head portion. In one embodiment, the head portion includes a connection flange to attach the cleaning skirt. In one embodiment, the cleaning skirt is a brush skirt. In another embodiment, the cleaning skirt is a foam skirt or a sponge skirt.

In a further aspect, the present invention broadly resides in a cleaning assembly for attachment to a spray nozzle head including

a head member having a head portion with an aperture, and a cleaning skirt extending from the head portion when in use; and

a spray nozzle head collar attachable to the spray nozzle head and positionable at least partially within the aperture to allow discharge of liquid from the spray nozzle head through the aperture.

Preferably the spray nozzle head collar has at least one convergent portion to allow the spray nozzle head to be inserted at least partially therein and form a friction fit with the spray nozzle head collar.

Preferably the aperture is tapered to form a friction fit between the spray nozzle head collar and the aperture. Preferably the spray nozzle head collar has a tapered external portion which substantially corresponds to the taper of the aperture.

In another aspect, the present invention broadly resides in a cleaning assembly for attachment to a spray nozzle head including:

a head member having a head portion with an off-centre aperture and a cleaning skirt extending from the head portion when in use; and

a spray nozzle head collar attachable to the spray nozzle head and positionable at least partially within or outside of the aperture to allow discharge of liquid from the spray nozzle head through the aperture.

In a preferred embodiment, the cleaning assembly further includes a locking means to releasably secure the spray nozzle head collar at least partially within or outside of the aperture. Preferably the locking means includes one or more of a pin, bolt, set screw, clamp, and/or a cam. In the preferred embodiment, the locking means is a set screw which screws into a threaded hole in the head portion which extends through to the aperture. In use, the set screw preferably extends into the aperture and abuts the spray nozzle head collar to secure the spray nozzle head collar in the aperture.

In an alternate embodiment, the locking means includes a thread located on the spray nozzle head collar and a corresponding thread on an outer or inner surface of the aperture.

If the spray nozzle head collar is positioned at least partially within the aperture, the head portion preferably has a lip extending into the aperture providing an abutment for the spray nozzle head collar so that the spray nozzle head collar does not pass through the aperture.

The cleaning skirt is preferably integrally formed with or attachable to the head portion. In one embodiment, the head portion includes a connection flange to attach the cleaning skirt.

In one embodiment, the cleaning skirt is a brush skirt. In another embodiment, the cleaning skirt is a foam skirt or a sponge skirt.

If the spray nozzle head collar is positioned outside of the aperture, the head portion preferably has a head flange defining the aperture and when in use, the spray nozzle head collar fits over at least a part of the head flange. When in use the spray nozzle head collar is preferably releasably attached to the head flange. In a preferred embodiment, the spray nozzle head collar is a flexible rubber or neoprene coupling that is attachable to the head flange by an interference fit.

In one preferred embodiment, the spray nozzle head collar has a lip to assist in locating the spray nozzle head with the spray nozzle head collar. Preferably the lip assists to prevent unintended withdrawal of the spray nozzle head from the spray nozzle head collar. In an alternate embodiment, the spray nozzle head collar has a rebate portion to assist in securing the spray nozzle head to the spray nozzle head collar, with a portion of the spray nozzle head located in the rebate portion.

In another preferred embodiment, the spray nozzle head collar is a coupling with a spray nozzle head connection portion attachable to the spray nozzle head and a head connection portion attachable to the head portion. The diameter of the coupling preferably expands from the head connection portion to the spray nozzle head connection portion. The diameter of the coupling preferably expands in order to accommodate spray nozzle heads of different sizes.

In one embodiment, the cleaning assembly includes a plurality of spray nozzle head collars, with each spray nozzle head collar having a different internal dimension to fit spray nozzle heads of different sizes.

Preferably the cleaning assembly further includes a brake ring positionable over a spray selector ring of the spray nozzle head to prevent accidental movement of the selector ring to a different setting. Preferably the brake ring is made of rubber or silicone. Preferably the brake ring has a tab extending from a portion thereof. Preferably the tab enables easy manipulation of the brake ring.

In another aspect, the present invention broadly resides in a cleaning assembly for attachment to a spray nozzle head including:

a head member having a head portion with a head flange at least partially defining an off-centre aperture, and a cleaning skirt extending from the head portion when in use; and

a spray nozzle head collar attachable to the spray nozzle head and positionable about at least part of the head flange.

Preferably when in use, the spray nozzle head collar is attached to the head flange by interference fit. In one embodiment, when in use, the spray nozzle head collar is additionally or alternatively attached to the head flange by a clamp.

Preferably the spray nozzle head collar is made of rubber, neoprene and/or silicone.

In one embodiment, the head flange has a rebate portion and the spray nozzle head collar has a lip which is engageable with the rebate portion to secure the spray nozzle head collar to the head flange. In another embodiment, the head flange has a lip and the spray nozzle head collar has a rebate portion which is engageable with the lip to secure the spray nozzle head collar to the head flange.

In a further aspect, the present invention broadly resides in a cleaning assembly for attachment to a spray nozzle head including:

a head member having a head portion with an aperture, and a cleaning skirt extending from the head portion when in use; and

a spray nozzle head collar attachable to the spray nozzle head and positionable at least partially within or outside of the aperture to allow discharge of liquid from the spray nozzle head through the aperture.

Preferably the aperture is located off-centre relative to the head portion.

In another aspect, the present invention broadly resides in a cleaning assembly for attachment to a spray nozzle head including:

a head member having a head portion with a head flange at least partially defining an aperture, and a cleaning skirt extending from the head portion when in use; and

a spray nozzle head collar attachable to the spray nozzle head and positionable about at least part of the aperture flange to allow discharge of liquid from the spray nozzle head through the aperture.

Preferably the aperture is located off-centre relative to the head portion.

Preferably the spray nozzle head is part of a spray wand.

Preferably the head portion is formed by injection moulding. Preferably the head portion is made from a plastic material.

Preferably the spray nozzle head collar is made of a plastic, rubber, neoprene and/or silicone material.

In an alternate embodiment, the aperture and the spray nozzle head collar have a non-circular shape to aid in locating the spray nozzle head in a desired orientation.

In one embodiment, the spray nozzle head collar includes a cut out or a window such that in use, a setting of a spray selector ring of the spray nozzle head is visible through the cut out or window.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 shows a perspective view of a cleaning assembly according to a first preferred embodiment of the invention;

FIG. 2 shows a bottom view of the cleaning assembly as shown in FIG. 1;

FIG. 3 shows a perspective view of a cleaning assembly according to a second embodiment of the invention;

FIG. 4 shows a perspective view of the cleaning assembly as shown in FIG. 3 in an assembled state;

FIG. 5 shows a top view of the cleaning assembly as shown in FIG. 4;

FIG. 6 shows a perspective view of a cleaning assembly according to a third preferred embodiment of the invention;

FIG. 7 shows a perspective view of a cleaning assembly according to a fourth embodiment of the invention;

FIG. 8a shows an exploded view of a fifth preferred embodiment of a cleaning assembly without a cleaning skirt;

FIG. 8b is a front view of the cleaning assembly as shown FIG. 8a;

FIG. 8c is a top view of the cleaning assembly as shown FIG. 8a;

FIG. 9a is an assembled view of the cleaning assembly shown in FIG. 8a;

FIG. 9b is a front view of the cleaning assembly as shown in FIG. 9a;

FIG. 9c is a top view of the cleaning assembly as shown in FIG. 9a;

FIG. 10a shows an exploded view of a sixth preferred embodiment of a cleaning assembly without a cleaning skirt;

FIG. 10b is a front view of the cleaning assembly as shown in FIG. 10a;

FIG. 10c is a top view of the cleaning assembly as shown in FIG. 10a;

FIG. 11 is a view of the cleaning assembly of FIG. 10a;

FIG. 12a is a perspective view of a seventh preferred embodiment of a cleaning assembly without a cleaning skirt;

FIG. 12b is a front view of the cleaning assembly as shown in FIG. 12a;

FIG. 12c is a top view of the cleaning assembly as shown in FIG. 12a;

FIG. 13a a perspective view of an eighth preferred embodiment of a cleaning assembly without a cleaning skirt;

FIG. 13b is a front view of the cleaning assembly as shown in FIG. 13a;

FIG. 13c is a top view of the cleaning assembly as shown in FIG. 13a;

FIG. 14a is a perspective view of the fifth preferred embodiment of the cleaning assembly with a cleaning skirt;

FIG. 14b is a front view of the cleaning assembly as shown in FIG. 14a; and

FIG. 14c is a top view of the cleaning assembly as shown in FIG. 14a.

### DETAILED DESCRIPTION OF THE PREFERRED EMBODIMENTS

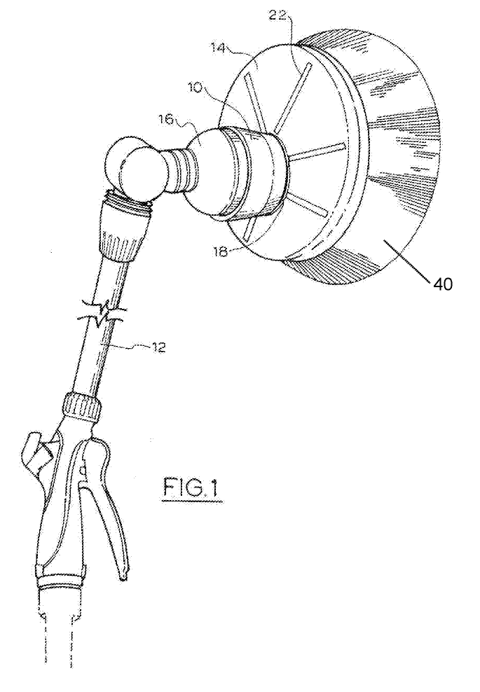

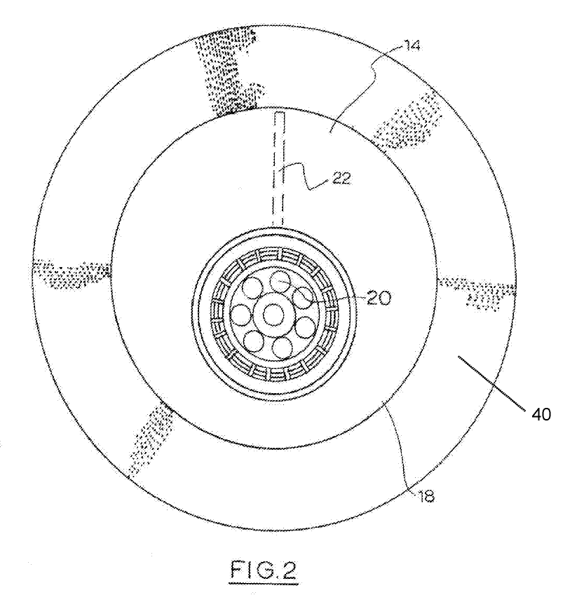

With reference to FIGS. 1 and 2, there is shown a connector in the form of a spray nozzle head collar 10 for attaching a hose attachment in the form of a water wand 12 to a head portion 14 according to a first preferred embodiment of the present invention. The head portion 14 has a cleaning skirt in the form of a brush skirt 40 extending therefrom. In other forms of the invention, the brush skirt may be substituted for a sponge or a foam skirt. In yet other forms of the invention a combination of brush, sponge and/or foam cleaning skirts could be used with the head portion 14.

The water wand 12 has a circular spray nozzle head 16. The spray nozzle head collar 10 has a conical shape with a sloping surface, so that the spray nozzle head 16 forms a friction fit with the spray nozzle head collar 10 and is held in position on the head portion 14. The conical shape of the spray nozzle head collar 10 enables the head portion 14 to be fitted to water wands with spray nozzle heads of different diameters.

The aperture 18 is offset from the centre of the head portion 14 so that a nozzle 20 of the spray nozzle head 16 is in the centre of the head portion 14.

The spray nozzle head 16 has a number of different nozzles which can be used to spray water in different ways. A desired nozzle (e.g. nozzle 20) can be selected by rotating the spray nozzle head 16 to a desired setting.

The spray nozzle head 16 must be rotated to the desired setting before the spray nozzle head 16 is inserted into the spray nozzle head collar 10. The water is typically sprayed from a nozzle 20 located at 12 o'clock relative to the spray nozzle head 16. The most suitable setting for the nozzle 20 is typically a fan or cone water spray setting. The nozzle 20 should be aligned with a line 22 on the head portion 14. The line 22 is visible on both sides of the head portion 14. The line 22 should correspond to the widest portion of the head portion 14 relative to the aperture 18. If the nozzle 20 is aligned with the centre of the head portion 14, then the water spray from the nozzle 20 will be evenly distributed relative to the head portion 14.

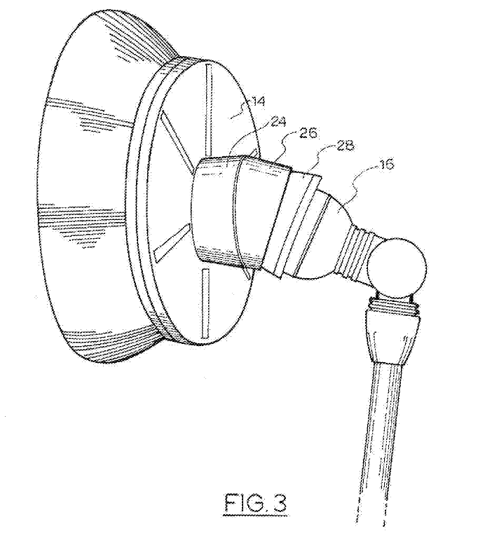

With reference to FIG. 3, there is shown a connector in the form of a spray nozzle head collar 24 and a first shim 26 and a second shim 28 of different sizes to suit the spray nozzle head 16 of the water wand 12 according to a second embodiment of the present invention. The spray nozzle head collar 24 is attached to the head portion 14. If the spray nozzle head 16 is too small to be attached directly to the spray nozzle head collar 24 by friction fit, then one of the other smaller shims 26 and 28 can be used as an adapter to form a friction fit between the spray nozzle head 16 and the spray nozzle head collar 24. Each shim 26,28 is progressively smaller than the next in the series. The connector 24 and/or the shims 26,28 hold the spray nozzle head 16 in position relative to the head portion 14.

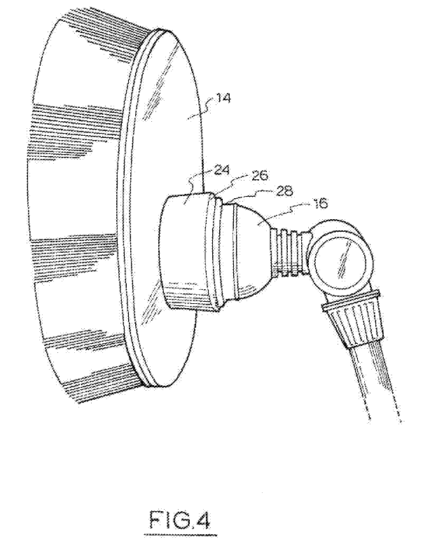

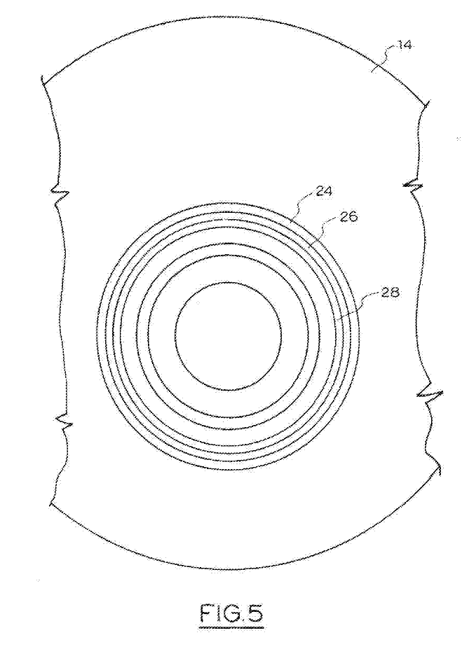

FIGS. 4 and 5 show the shims 26,28 compressed within the spray nozzle head collar 24.

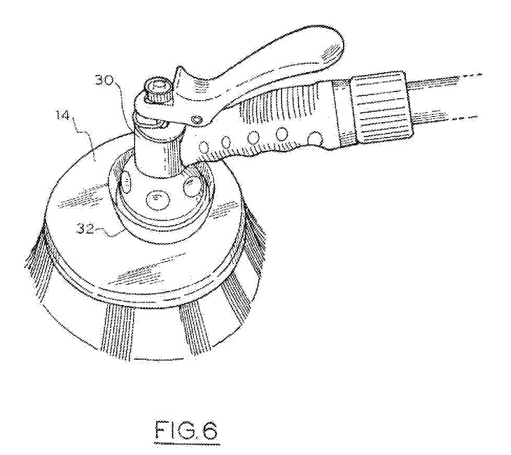

FIG. 6 shows a different form of a hose attachment in the form of a trigger sprayer 30 connected via a connector 32 to a head portion 14 according to a third preferred embodiment of the present invention.

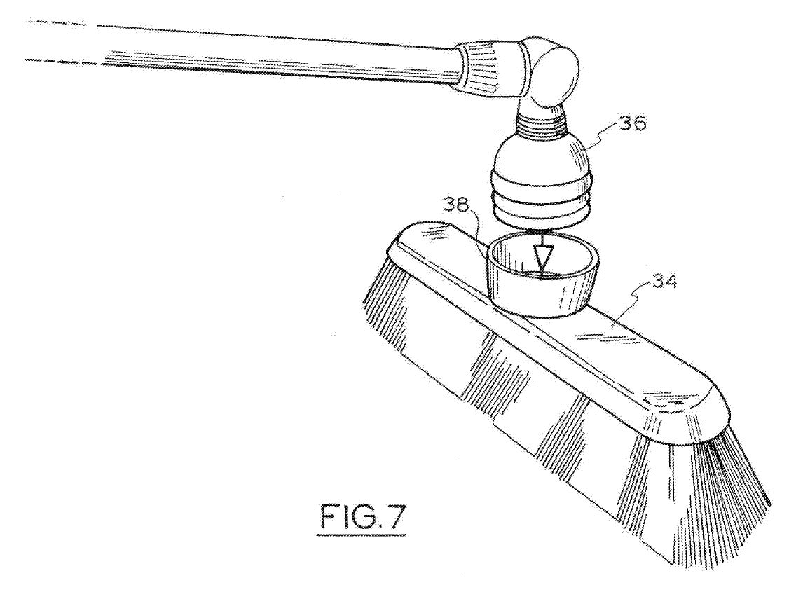

FIG. 7 shows a rectangular shaped head portion 34 interfacing with a spray nozzle head 36 via a connector in the form of a spray nozzle head collar 38 according to a fourth embodiment of the present invention.

Any shaped head portion can be used within the scope of the present invention. The cleaning assemblies can be adapted for any purpose, including washing cars, animals (such as dogs, cats, horses or cattle), or even windows.

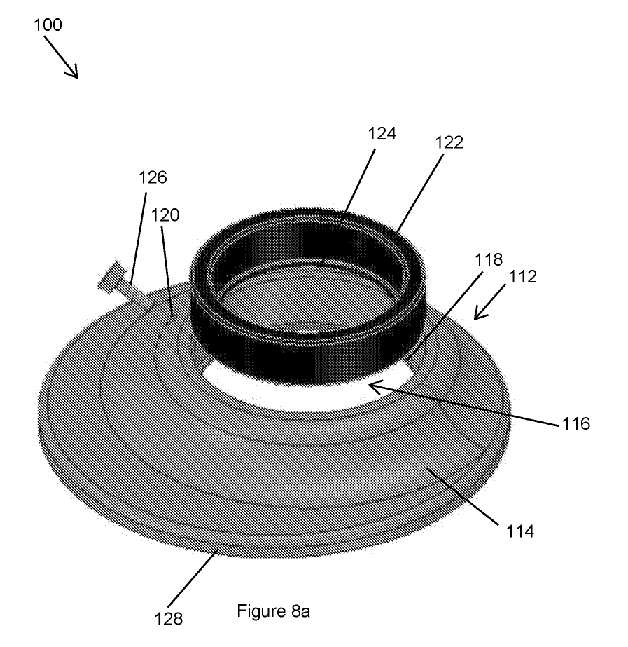

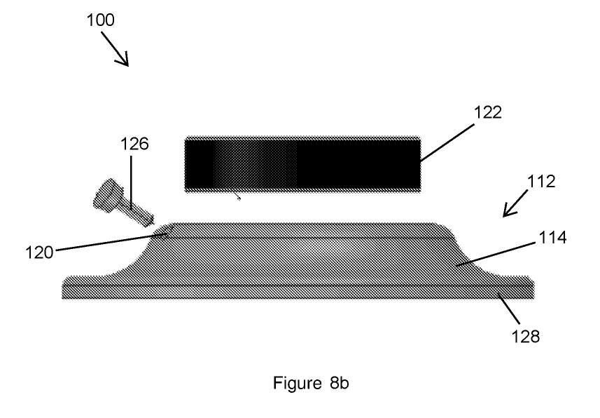

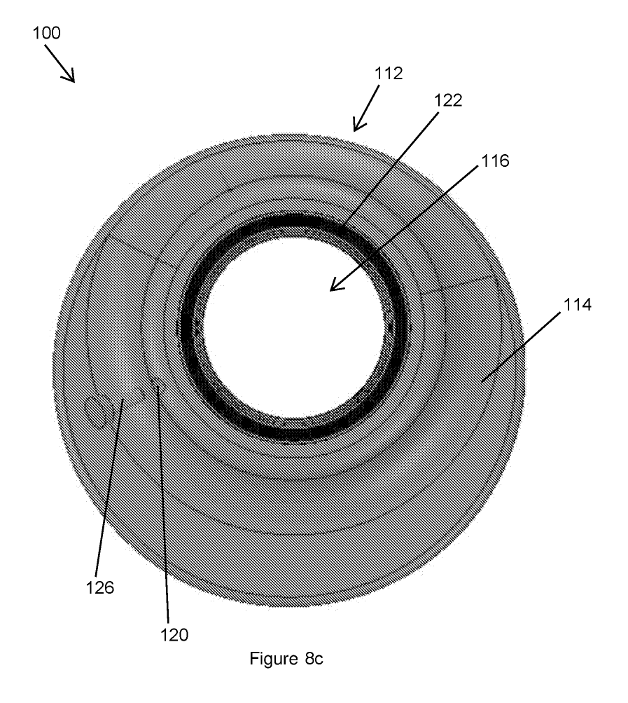

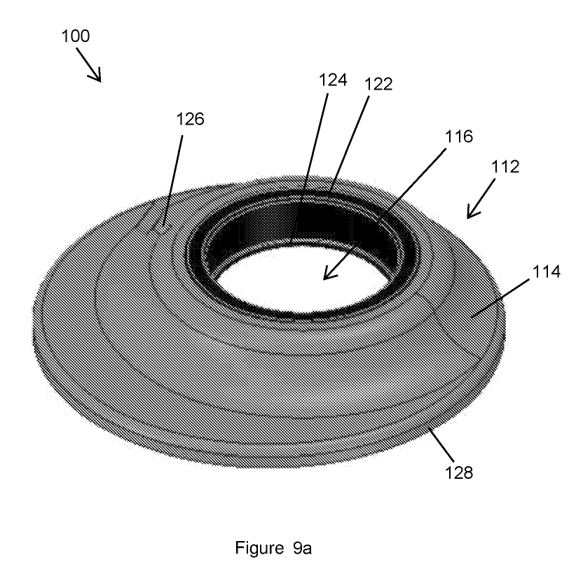

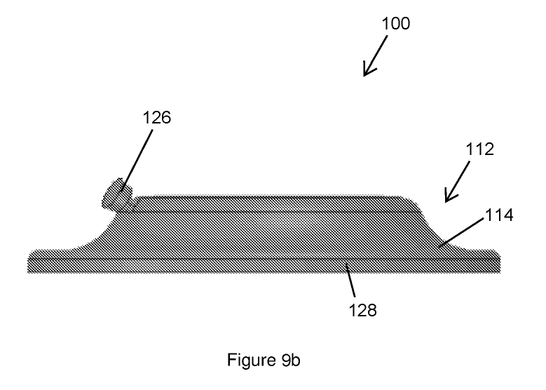

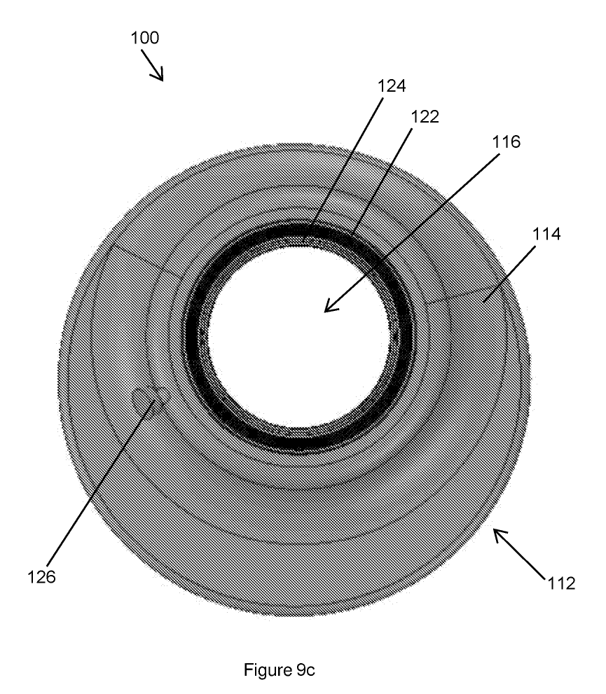

With reference to FIGS. 8a to 9c, there is shown a cleaning assembly 100 according to a fifth preferred embodiment of the present invention. The cleaning assembly 100 has a head member 112 with a head portion 114. The head portion 114 has an aperture 116 formed therein. The aperture 116 is located off-centre relative to the head portion 114 to position a selected nozzle of a spray nozzle head (not shown) centrally relative to the head portion 114.

A threaded hole 120 extends between a top surface of the head portion 114 and the aperture 116.

A spray nozzle head collar 122 is positionable in the aperture 116. A peripheral lip 118 extends into the aperture 116. The peripheral lip 118 abuts the spray nozzle head collar 122 when the spray nozzle head collar 122 is positioned in the aperture 116 and prevents the spray nozzle head collar 122 from sliding all the way through the aperture 116.

The spray nozzle head collar 122 has a collar lip 124. In use, the collar lip 124 abuts the spray nozzle head (not shown) when the spray nozzle head is inserted into the spray nozzle head collar 122.

The spray nozzle head collar 122 is releasably secured in the aperture 116 by a locking means in the form of a set screw 126. The set screw 126 is located in the threaded hole 120 and abuts the spray nozzle head collar 122 to retain the spray nozzle head collar 122 in the aperture 116.

The head member 112 has a connection flange 128 to which a cleaning skirt (not shown) is attachable.

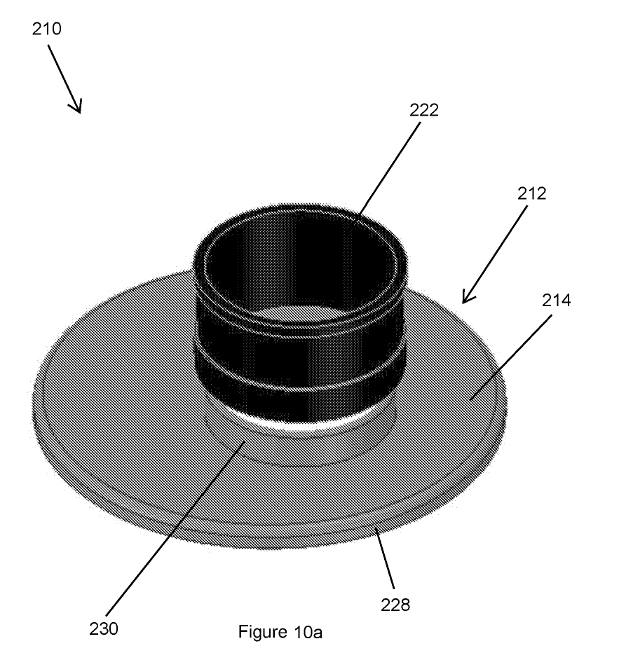

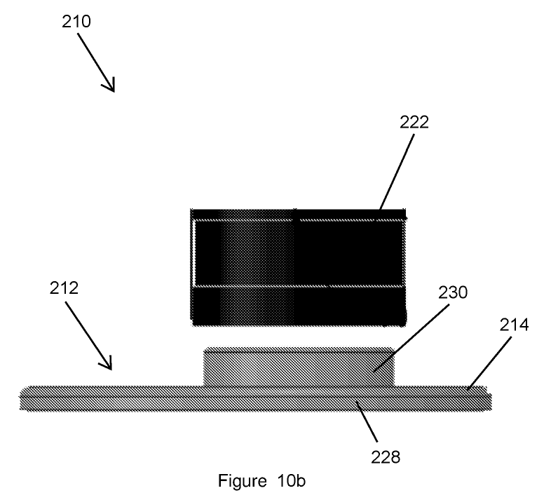

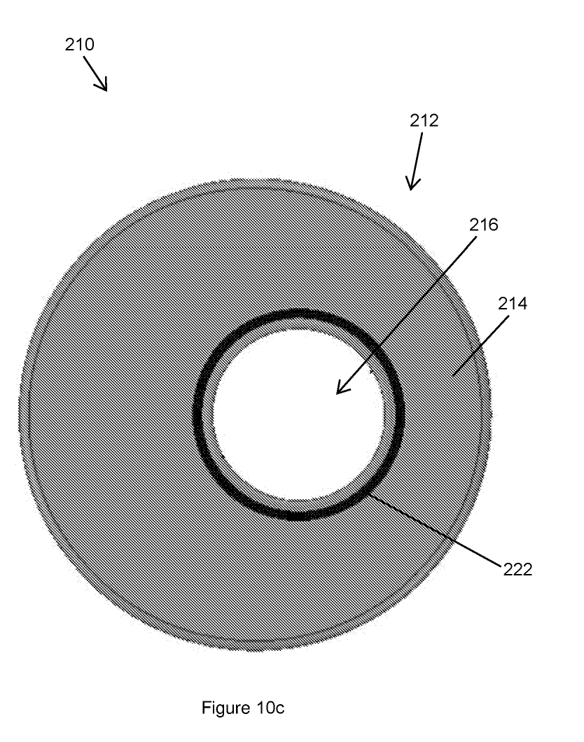

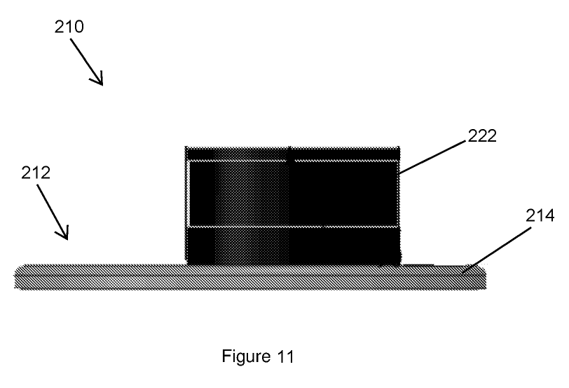

With reference to FIGS. 10a to 11, there is shown a cleaning assembly 210 according to a sixth preferred embodiment of the present invention.

The cleaning assembly 210 has a head member 212 having a head portion 214. The head portion 214 has a head flange 230 which defines an aperture 216. The aperture 216 is located off-centre relative to the head portion 214.

A spray nozzle head collar 222 is positionable outside of the aperture 216 and positionable about at least part of the head flange 230. In use, the spray nozzle head collar 222 is attached to the head flange 230 by interference fit. The spray nozzle head collar 222 is attachable to a spray nozzle head (not shown), which in use is at least partially inserted into the spray nozzle head collar 222.

The internal diameter of the collar is substantially constant along its length.

In one embodiment (not shown) the spray nozzle head collar has one or more ribs on an inner portion thereof to assist in retaining the spray nozzle head within the spray nozzle head collar.

The head member 212 has a connection flange 228 to which a cleaning skirt (not shown) is attachable.

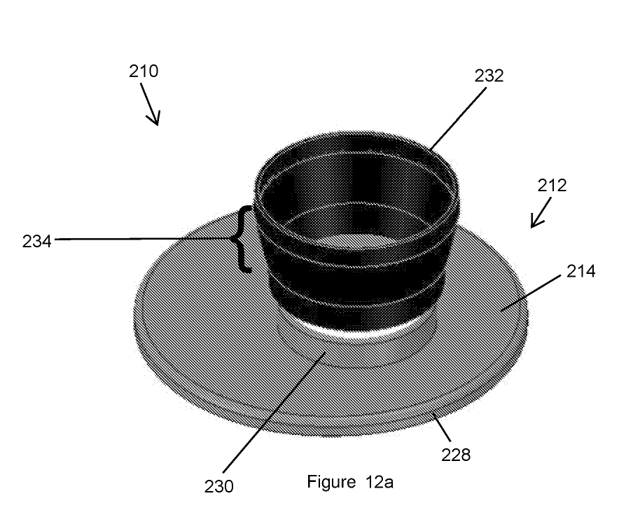

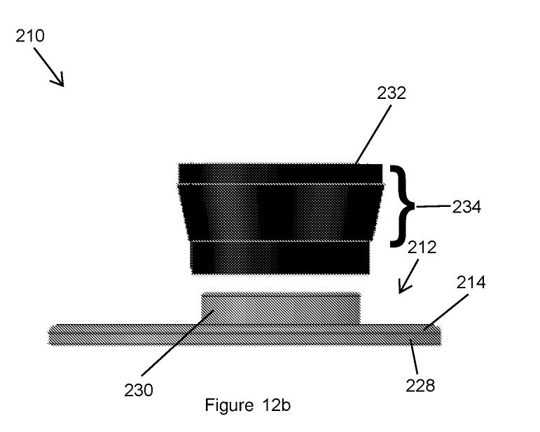

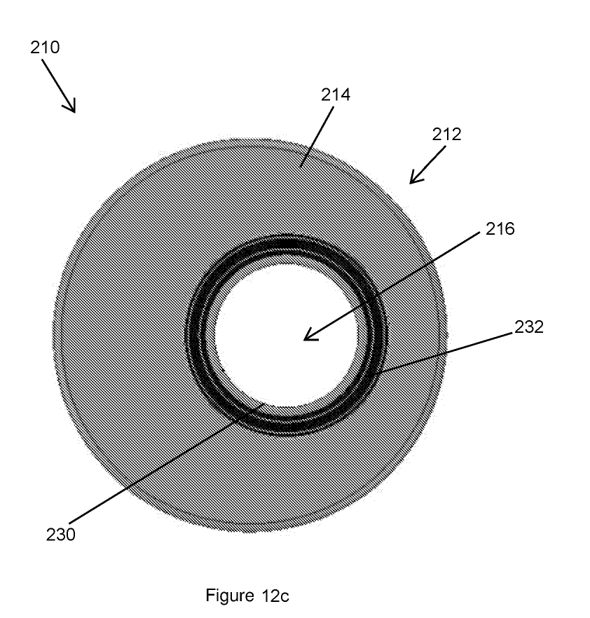

FIGS. 12a to 12c show a cleaning assembly 210 according to a seventh preferred embodiment. The spray nozzle head collar 232 has an outwardly expanding spray nozzle head connection portion 234 which can accommodate spray nozzle heads of different sizes. The flange portion of the spray nozzle head collar 232 which surrounds the head flange 230 has the same internal diameter as the size of the head flange 230 and is substantially constant.

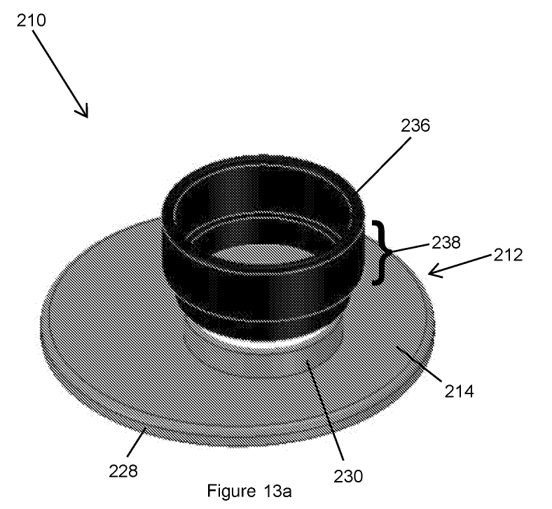

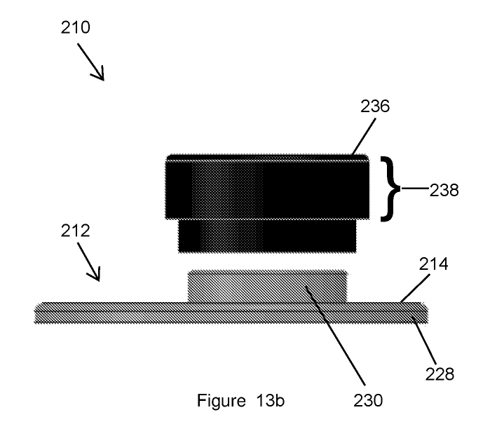

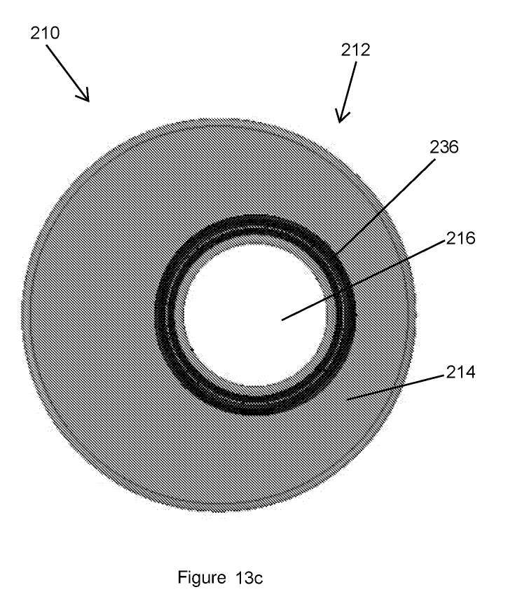

FIGS. 13a to 13c show a cleaning assembly 210 according to an eighth preferred embodiment. The cleaning assembly has a stepped spray nozzle head collar 236. The spray nozzle head collar 236 has an expanded spray nozzle head connection portion 238. The expanded spray nozzle head connection portion 238 can accommodate a large spray nozzle head. The flange portion of the spray nozzle head collar 236 which surrounds the head flange 230 is the same diameter as the flange portion in the sixth and seventh embodiment.

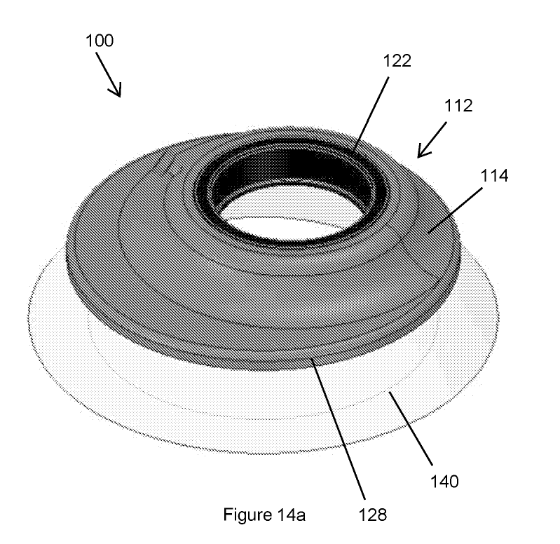

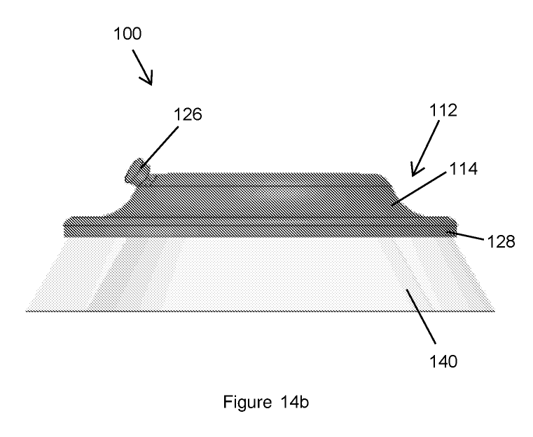

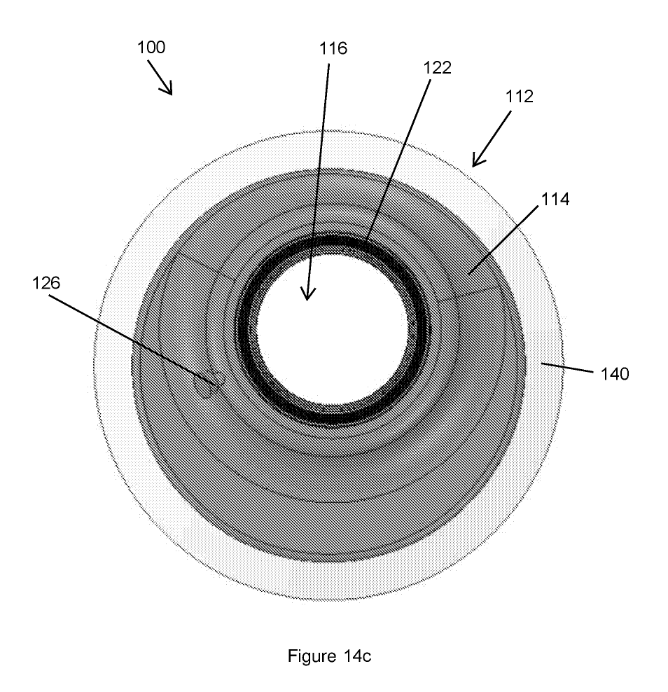

FIGS. 14a to 14c show a cleaning assembly 100 according to the fifth preferred embodiment, having a cleaning skirt in the form of a brush skirt 140 extending from the head portion 114. The brush skirt 140 attaches to the connection flange 128.

In another embodiment (not shown) the cleaning skirt is a foam skirt.

In use, a nozzle from the spray nozzle head is selected to provide a spray of water at a desired force. The forced spray is used in combination with the brushes of the cleaning skirt to provide a more effective cleaning action.

The spray nozzle head typically has a selector ring which can be rotated to select a desired nozzle. In an embodiment (not shown), the cleaning assembly includes a brake ring which fits over a portion of the selector ring and secures the selector ring in position relative to the rest of the spray nozzle head to prevent accidental rotation of the selector ring.

### ADVANTAGES

An advantage of the preferred embodiment of the cleaning assembly includes a secure attachment of a spray nozzle head to the cleaning assembly.

Another advantage of the preferred embodiment of the cleaning assembly includes that spray nozzle heads of varying sizes can be attached to the head member.

A further advantage of the preferred embodiment of the cleaning assembly includes a more centralised spray relative to the head member for spray nozzle heads with a spray selector ring where the selected spray nozzle is not central to the spray nozzle head.

A high pressure spray provides a more efficient cleaning action and another advantage of the cleaning assembly of the preferred embodiment is that the cleaning skirt inhibits splash back from the high pressure spray.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A cleaning assembly for attachment to a spray nozzle head including:
a head member having a head portion with an aperture, and a cleaning skirt extending from the head portion when in use; and
a spray nozzle head collar attachable to the spray nozzle head and positionable at least partially within or outside of the aperture to allow discharge of liquid from the spray nozzle head through the aperture.

2. A cleaning assembly as claimed in claim 1, wherein the spray nozzle head collar has at least one tapered internal portion to allow the spray nozzle head to be inserted at least partially therein and form a friction fit with the spray nozzle head collar.

3. A cleaning assembly as claimed in claim 1, wherein the spray nozzle head collar has a tapered external portion to form a friction fit with a wall of the aperture.

4. A cleaning assembly as claimed in claim 3 wherein the wall of the aperture is a tapered, convergent or sloping wall.

5. A cleaning assembly as claimed in claim 1, wherein the aperture is located off-centre relative to the head portion.

6. A cleaning assembly as claimed in claim 1, wherein the cleaning skirt is a brush skirt.

7. A cleaning assembly as claimed in claim 1, wherein the cleaning skirt is a foam skirt or a sponge skirt.

8. A cleaning assembly as claimed in claim 1, wherein the spray nozzle head collar has a lip to inhibit unintended withdrawal of the spray nozzle head from the spray nozzle head collar.

9. A cleaning assembly as claimed in claim 1, including one or more shims locatable between the spray nozzle head collar and the spray nozzle head to form the friction fit between the spray nozzle head collar and the spray nozzle head.

10. A cleaning as claimed in claim 1, further including a locking means to releasably secure the spray nozzle head collar at least partially within or outside of the aperture.

11. A cleaning assembly as claimed in claim 10, wherein the locking means includes one or more of a pin, bolt, set screw, clamp, and/or a cam.

12. A cleaning assembly as claimed in claim 10, wherein the locking means is a set screw which in use screws into a threaded hole in the head portion which extends through to the aperture, and wherein in use the set screw extends into the aperture and abuts the spray nozzle head collar to secure the spray nozzle head collar in the aperture.

13. A cleaning assembly as claimed in claim 10, wherein the locking means includes a thread located on the spray nozzle head collar and a corresponding thread on an outer or inner surface of the aperture.

14. A cleaning assembly as claimed in claim 1, wherein the head portion has a head flange defining the aperture, and when in use, the spray nozzle head collar fits over at least a part of the head flange.

15. A cleaning assembly as claimed in claim 14, wherein the spray nozzle head collar is a flexible rubber or neoprene coupling that is attachable to the head flange by an interference fit.

16. A cleaning assembly as claimed in claim 15, wherein the spray nozzle head collar is additionally attachable to the head flange by a clamp.

17. A cleaning assembly as claimed in claim 14, wherein one of the head flange or the spray nozzle head collar has a rebate portion and the other of the head flange or the spray nozzle head collar has a lip which is engageable with the rebate portion to secure the spray nozzle head collar to the head flange.

18. A cleaning assembly as claimed in claim 1, including a plurality of spray nozzle head collars, with each spray nozzle head collar having a different internal dimension to fit spray nozzle heads of different sizes.

19. A cleaning assembly as claimed in claim 1, wherein the spray nozzle head collar includes a cut out or a window, such that in use, a setting of a spray selector ring of the spray nozzle head is visible through the cut out or window.

20. A cleaning assembly as claimed in claim 1, wherein the aperture and the spray nozzle head collar have a non-circular shape to aid in locating the spray nozzle head in a desired orientation.
